(19) United States
(12) Patent Application Publication
(10) Pub. No.: US 2015/0365612 A1
(43) Pub. Date: Dec. 17, 2015

(54) IMAGE CAPTURE APPARATUS AND IMAGE COMPENSATING METHOD THEREOF

(71) Applicant: Altek Semiconductor Corp., Hsinchu City (TW)

(72) Inventors: Tsan-Wei Wang, Taitung County (TW); Shan-Lung Chao, Hsinchu City (TW); Hong-Long Chou, Hsinchu County (TW); Bo-Qi Zhuang, Changhua County (TW); Shun-Sheng Wang, Miaoli County (TW)

(21) Appl. No.: 14/325,388

(22) Filed: Jul. 8, 2014

(30) Foreign Application Priority Data
Jun. 16, 2014 (TW) 103120714

(51) Int. Cl. H04N 5/357; G06T 7/40; H04N 9/04; H04N 5/232

(52) U.S. Cl. CPC H04N 5/3572; H04N 5/23229; G06T 7/408; H04N 9/045; G06T 2207/10024; G06T 2207/10004; G06T 2207/10144

(57) ABSTRACT

An image capture device and an image compensating method are provided. The image compensating method is for the image capture device and includes following steps. An image is captured under a current light source. The current light source is detected and a white balance process is executed so as to obtain current gain information of the current light source. A modifying parameter is determined according to the current gain information and reference gain information. The reference gain information is corresponding to a plurality of predefined color temperatures which are different to each other. A first shading compensation table is modified by using the modifying parameter to obtain a second shading compensation table. The image is compensated by using the second shading compensation table so as to generate a compensated image.

### CROSS-REFERENCE TO RELATED APPLICATION

This application claims the priority benefit of Taiwan application serial no. 103120714, filed on Jun. 16, 2014. The entirety of the above-mentioned patent application is hereby incorporated by reference herein and made a part of this specification.

### BACKGROUND OF THE INVENTION

1. Field of the Invention

The invention relates to an image processing method, and particularly relates to an image capture device and an image compensating method thereof.

2. Description of Related Art

In the conventional image capture device, a photo-sensing element such as a charge-coupled device (CCD) or a complementary metal-oxide semiconductor (CMOS) is used to capture light entering the device through a lens. When passing through a lens system, the light is refracted to present an image on the CCD or CMOS. However, since the refraction of light results in reduction of energy, and a refracting angle of light passing through the periphery of the lens is greater than a refracting angle of light passing through the center of the lens, the image taken becomes darker on the periphery while brighter at the center. The effect is known as a color shading effect of image. For handheld electronic devices, which are designed with the aim of being thinner, lighter, compacter, and smaller, the shading effect becomes even more salient through miniaturization of the devices.

To solve the shading effect of the image, a predefined compensation parameter table is stored in the image capture device manufactured according to the conventional technology to allow the image capture device to adjust all of the images taken by the user based on the compensation parameter table, thereby suppressing the shading effect of the captured images. In general, the predefined compensation parameter table is an adjustment parameter for a single light source.

However, when the user captures image by using the image capturing device, the user may take pictures under different light sources. Using the compensation parameter table for one single light source to compensate for the shading of the images may result in the issue that the compensated images are less preferable than expected. For example, the compensated images may be found to have the issue of partial color shift or color inconsistency. Therefore, people skilled in the art need to work on a more preferable image compensating method to improve the image quality.

### SUMMARY OF THE INVENTION

In view of the foregoing, the invention provides an image capture device and an image compensating method thereof capable of generating a suitable shading compensation parameter for image compensation based on a shooting light source, so as to effectively suppress a shading effect and improve an image quality.

The embodiments of the invention provide an image compensating method adapted for an image capture device. The method includes steps as follows. First of all, an image is captured under a current light source. In addition, the current light source is detected and a white balance process is executed to obtain current gain information associated with the current light source. Then, a modifying parameter is determined based on the current gain information and a plurality of reference gain information. The reference gain information is respectively corresponding to a plurality of predefined color temperatures mutually different from each other. Then, the modifying parameter is used to modify a first shading compensation table so as to obtaining a second shading compensation table. Finally, the second shading compensation table is used to compensate the image so as to generate a compensated image.

According to an embodiment, the step of determining the modifying parameter based on the current gain information and the reference gain information includes using a projection function to determine an index position of the current gain information. The projection function is generated based on the reference gain information. In addition, the modifying parameter is determined based on the index position and a plurality of reference positions respectively corresponding to the reference gain information.

According to an embodiment of the invention, before the step of using the modifying parameter to modify the first shading compensation table so as to obtain the second shading compensation table, the method further includes using a projection function to determine an index position of the current gain information. The projection function is generated based on the reference gain information. A linear interpolation process is performed to a plurality of predefined compensation tables based on the index position so as to generate the first shading compensation table. The predefined compensation tables respectively correspond to the plurality of predefined color temperatures mutually different from each other.

According to an embodiment of the invention, the step of using the modifying parameter to modify the first shading compensation table so as to obtaining the second shading compensation table includes obtaining an adjustment parameter table based on the modifying parameter and a predefined curve, and using the adjustment parameter table to modify a plurality of compensation values in the first shading compensation table so as to obtain the second shading compensation table.

According to an embodiment of the invention, the modifying parameter includes a first adjustment parameter corresponding to a first color channel and a second adjustment parameter corresponding to a second color channel. The step of obtaining the adjustment parameter table based on the modifying parameter and the predefined curve includes obtaining a first adjustment parameter table of the adjustment parameter table based on the first adjustment parameter and a first curve of the predefined curve. In addition, the first adjustment parameter table corresponds to the first color channel. In addition, a second adjustment parameter table of the adjustment parameter table is obtained based on the second adjustment parameter and a second curve of the predefined curve. In addition, the second adjustment parameter table corresponds to the second color channel.

According to an embodiment of the invention, the step of using the adjustment parameter table to modify the plurality of compensation values in the first shading compensation table so as to obtain the second shading compensation table, includes using the first adjustment parameter table to modify a plurality of first channel compensation values corresponding to the first color channel in the first shading compensation table, using the second adjustment parameter table to modify a plurality of second channel compensation values corresponding to the second color channel in the first shading compensation table, and recording the modified first channel compensation values and the modified second channel compensation values as the second shading compensation table.

From another perspective, the embodiments of the invention provide an image capture device, including a storage unit recording a plurality of modules and one or more processing units. The one or more processing units are coupled to the storage unit to access and execute the modules recorded in the storage unit. The modules include a capturing module, a white balance module, a parameter determining module, a modifying module, and an image compensating module. The capturing module captures an image under a current light source. The white balance module detects the current light source and executes a white balance process to obtain current gain information associated with the current light source. The parameter determining module determines a modifying parameter based on the current gain information and a plurality of reference gain information. The reference gain information is respectively corresponding to a plurality of predefined color temperatures mutually different from each other. The modifying module uses the modifying parameter to modify a first shading compensation table so as to obtain a second shading compensation table. The image compensating module uses the second shading compensation table to compensate the image so as to generating a compensated image.

Based on the above, in the embodiments of the invention, the image capture device may obtain the corresponding modifying parameter by comparing the current gain value about the white balance information and the plurality of predefined reference gain values, and use the modifying parameter to modify the shading compensation table established for a specific color temperature. Therefore, the image capture device according to the embodiments of the invention is capable of generating the shading compensation tables suitable for different light source environments. Accordingly, the embodiments of the invention not only provide a preferable compensation performance to suppress the shading effect, but also avoid color inconsistency in the image after shading compensation, making the image quality of the image capture device further improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an image capture device according to an embodiment of the invention.

FIG. 2 is a flowchart illustrating an image compensating method according to an embodiment of the invention.

FIG. 3 is a schematic view illustrating an operation of an image compensating method according to an embodiment of the invention.

FIG. 4 is schematic block diagram illustrating an image capture device according to an embodiment of the invention.

FIG. 5 is a flowchart illustrating an image compensating method according to an embodiment of the invention.

FIG. 6A is a schematic view illustrating a relation between color temperature and white balance gain according to an embodiment of the invention.

FIG. 6B is a schematic view illustrating coordinate positions after transformation according to an embodiment of the invention.

FIG. 7 is a schematic view illustrating obtaining a second shading compensation table according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Generally speaking, an image capture device is built with a shading compensation table for a specific light source when being dispatched from the factory. The built-in shading compensation table is adapted for shading compensation to an image taken by using the image capture device, so as to improve low brightness at a periphery or color shift at a corner of the image. To address the issue that the built-in shading compensation table becomes not applicable when a shooting environment changes, the built-in shading compensation table is further adjusted by using white balance information when shooting the image in the embodiments of the invention. In order to make the present invention more comprehensible, embodiments are described below as the examples to prove that the invention can actually be practiced.

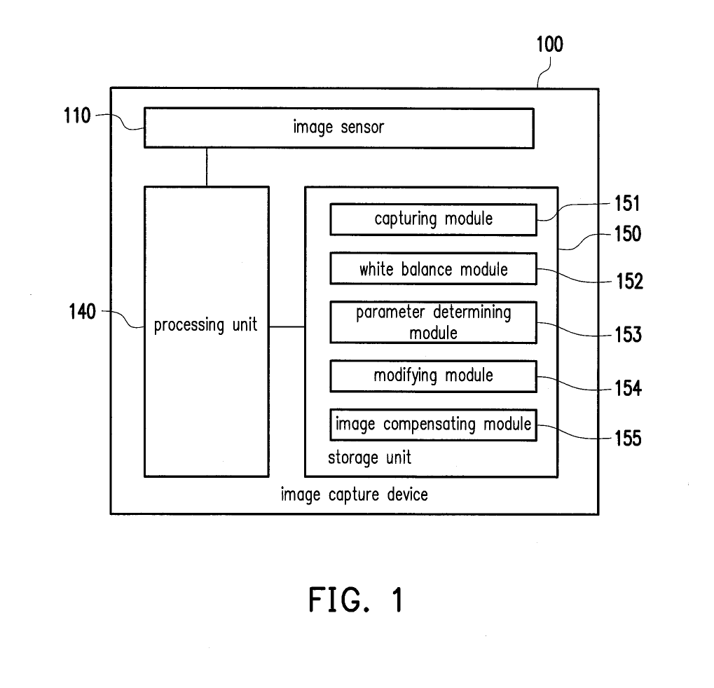

FIG. 1 is a block diagram illustrating an image capture device according to an embodiment of the invention. Referring to FIG. 1, an image capture device 100 of this embodiment may be a digital camera, a digital video camera, or other hand-held electronic devices having an image-capturing function, such as a smart phone, a tablet, etc. The above are only to name a few and the invention is not limited thereto. The image capture device 100 includes an image sensor 110, one or more processing units (in this embodiment, only a processing unit 140 is described as an example, but the invention is not limited thereto), and a storage unit 150.

The image sensor 110 may include a lens and a photo-sensing element. The photo-sensing element is a charge coupled device (CCD), a complementary metal-oxide semiconductor (CMOS) device, or other devices, for example. In addition, the image sensor 110 may further include elements such as an aperture, and the invention is not limited thereto.

The processing unit 140 is a central processing unit (CPU), a microprocessor, an application specific integrated circuit (ASIC), a programmable logic device (PLD), or other hardware devices having a computing capability, for example. The storage unit 150 is a random access memory (RAM), a flash memory, or other memory devices, for example, and is adapted to store data and a plurality of modules. In addition, the processing unit 140 is coupled to the storage unit 150 and adapted to execute the modules. The modules include a capturing module 151, a white balance module 152, a parameter determining module 153, a modifying module 154, and an image compensating module 155. These modules are computer programs, for example, and may be loaded into the processing unit 140 for image compensation.

In this embodiment, the white balance module 152 is realized as computer program software that may be loaded by the processing unit 140 to execute a white balance function of the image capture device 100. However, in another embodiment, the white balance module 152 may be independent from the storage unit 150 and realized in a form of hardware, such as a graphic processing unit (GPU), a digital signal processor (DSP), and a logic circuit, etc., and is capable of assisting the processing unit 140 in executing image processing functions such as white balance processing.

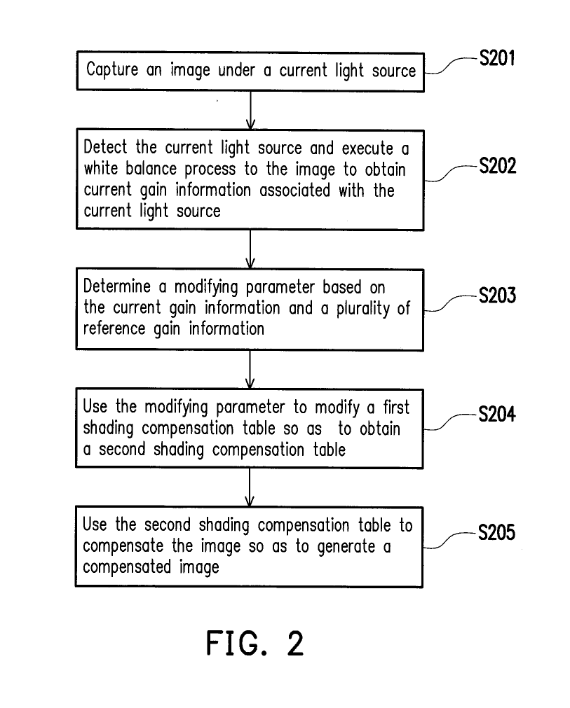

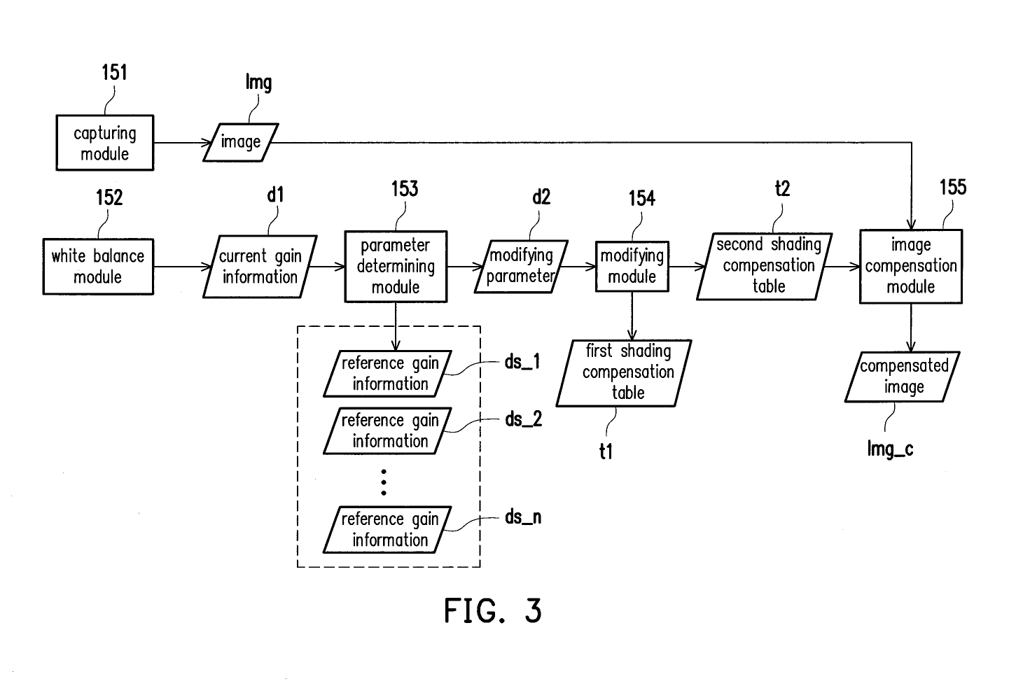

FIG. 2 is a flowchart illustrating an image compensating method according to an embodiment of the invention. FIG. 3 is a schematic view illustrating an operation of an image compensating method according to an embodiment of the invention. The method shown in FIGS. 2 and 3 are suitable for the image capture device 100 of FIG. 1. In the following, steps of the image compensating method of this embodiment are described in detail with reference to the components in the image capture device 100.

Referring to FIGS. 1 to 3, at Step S201, the image capturing module 151 captures an image Img by using the image sensor 110 under a current light source, and stores the image Img in the storage unit 450 or another unit for temporary storage. In addition, at Step S202, the white balance module 152 detects the current light source and executes a white balance process, so as to obtain current gain information associated with the current light source. Specifically, the white balance module 152 may execute an auto white balance (AWB) process so as to adjust images taken in environments of various light sources to a state, which meets the actual visual sense of human eyes without having a color shift. In other words, current gain information d1 is an adjusting parameter determined based on the current light source, and the current gain information d1 may adjust the image Img to a white-balanced state. The current gain information d1 may vary as a light source or a color temperature of a shooting scene varies. In an embodiment, the gain information d1 may include gain values respectively corresponding to different color channels.

Then, at Step S203, the parameter determining module 153 determines a modifying parameter d2 based on the current gain information d1 and a plurality of reference gain information ds_1, ds_2, . . . ds_n. It should be noted that the reference gain information ds_1, ds_2, . . . ds_n are respectively corresponding to a plurality of predefined color temperatures mutually different from each other. In other words, the reference gain information ds_1, ds_2, . . . ds_n may be used for adjusting images taken at different predefined color temperatures, such that the images taken at the predefined color temperatures may reach white balance. The predefined color temperatures may be set based on the designer's practical needs. The invention does not intend to limit setting of the predefined color temperatures.

Then, the reference gain information ds_1, ds_2, . . . ds_n are white balance adjusting parameters determined based on common light sources, for example. The common light sources are sunlight, fluorescent light, or light from other commonly seen illumination devices, for example. For example, the predefined color temperatures and the corresponding reference gain information ds_1, ds_2 . . . ds_n are, for example, recorded in a white balance look-up table. The parameter determining module 153 of this embodiment generates the modifying parameter d2 based on the plurality of known reference gain information ds_1, ds_2, . . . ds_n and the current gain information d1 at the shooting scene.

At Step S204, the modifying module 154 obtains a second shading compensation table t2 by using the modifying parameter d2 to modify the first shading compensation table t1. In addition, the first shading compensation table t1 and the second shading compensation table t2 respectively record a plurality of compensation values for performing shading compensation to the image taken by the image capture device 100. It should be noted that compensation values in the second shading compensation table t2 are generated by using the modifying parameter d2 to modify the compensation values of the first shading compensation table t1. Regarding the first shading compensation table t1, the first shading compensation table t1 of this embodiment may be stored in the storage unit 150 in advance, or may be generated based on a plurality of predefined compensation tables stored in the storage unit 150.

In other words, the first shading compensation table t1 may be set based on a single light source, or set by interpolating shading compensation tables corresponding to a plurality of different light sources. The invention is not limited thereto. Moreover, the invention does not intend to limit sizes of the first and second shading compensation tables. The first and second shading compensation tables may have compensation values respectively corresponding to pixels of the image Img. Alternatively, the first and second shading compensation tables may have compensation values respectively corresponding to each partition of the image Img.

Lastly, at step S205, the image compensating module 155 compensates the image Img by using the second shading compensation table t2, so as to generate a compensated image Img_c. In brief, the image compensating module 155 uses the compensation values of the second shading compensation table t2 to adjust pixel values of part or all of the pixels in the image, such that brightness of an outer periphery of the image Img may be increased, and a shading effect of the image Img may thus be suppressed. Since in the image capture device 100, the white balance parameter that the image Img corresponds to has been used as an adjusting factor to modify the shading compensation table, the modified second shading compensation table t2 is capable of preventing a partial color shift after performing shading compensation to the image.

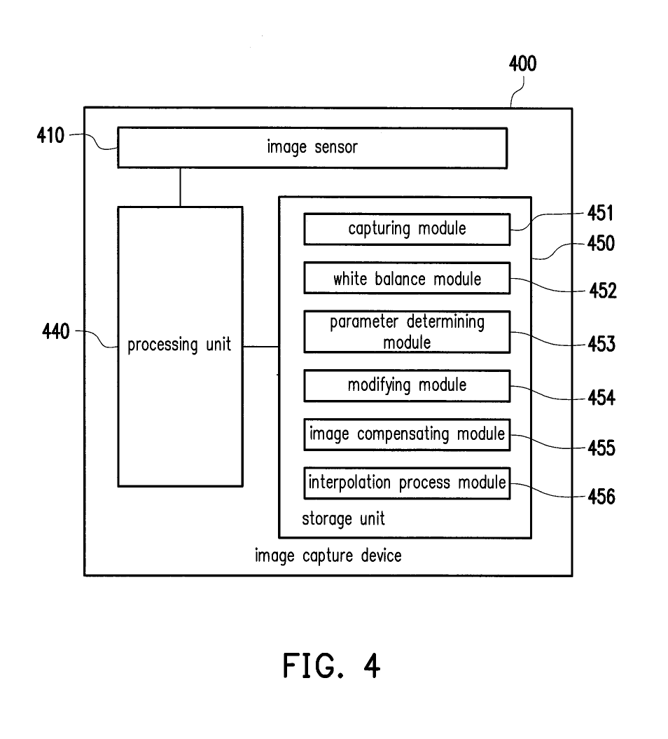

To provide further description with respect to how the reference gain information and the current gain information considered as white balance information are used to generate the suitable modifying parameter, another embodiment is provided below. FIG. 4 is schematic block diagram illustrating an image capture device according to an embodiment of the invention. Referring to FIG. 4, the image capture device 400 includes an image sensor 410, one or more processing units (in this embodiment, only a processing unit 440 is described as an example, but the invention is not limited thereto), and a storage unit 450. The storage unit 450 records a plurality of modules, and the modules includes a capturing module 451, a white balance module 452, a parameter determining module 453, a modifying module 454, and an image compensating module 455.

The image capture device 400 shown in FIG. 4 is similar to the image capture device 100 shown in FIG. 1. Therefore, like or similar components will not be described again below. It should be noted that, the embodiment shown in FIG. 4 is different in that the image capture device 400 further includes an interpolating process module 456. The interpolating process module 456 may perform linear interpolation to a plurality of predefined compensation tables to generate an interpolated shading compensation table.

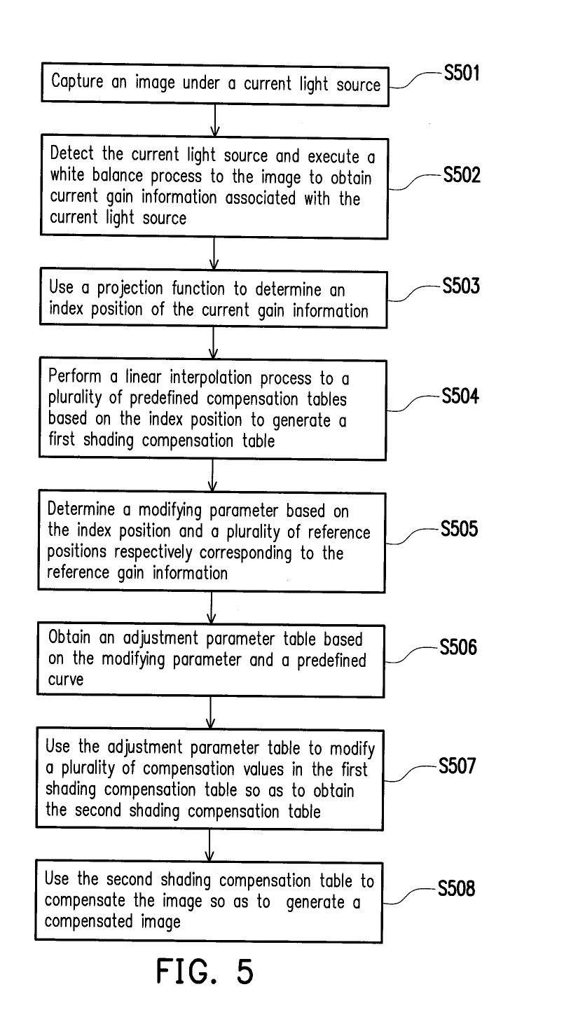

FIG. 5 is a flowchart illustrating an image compensating method according to an embodiment of the invention. The method shown in FIG. 5 is suitable for the image capture device 400 of FIG. 4. In the following, steps of the image compensating method of this embodiment are described in detail with reference to the components in the image capture device 400.

It should be noted that for the convenience and to clearly describe the embodiment, reference gain information individually corresponding to three different predefined color temperatures are used as an example to describe the embodiment. However, the invention is not limited thereto. The three predefined color temperatures may be set based on practical needs, and the invention is not limited thereto. Moreover, the storage unit 450 of the image capture device 400 stores predefined compensation tables respectively corresponding to the three different predefined color temperatures. Specifically speaking, when the factory manufactures the image capture device 400, the designer may perform computation to come up with the three predefined compensation tables for the three predefined color temperatures, and the predefined compensation tables are then in the storage unit 450. In addition, reference gain information respectively corresponding to the three color temperatures may be computed and stored in the storage unit 450 in advance.

Referring to FIGS. 4 and 5, at Step S501, the image capturing module 451 captures an image under the current light source by using the image sensor 410. At Step S502, the white balance module 452 detects the current light source and executes a white balance process, so as to obtain the current gain information associated with the current light source. Steps S501 and S502 are similar to or the same as Steps S201 and S202 in the previous embodiment. Therefore, no further details in this respect will be reiterated below. In this embodiment, it is assumed that a first color channel is a red channel, and a second color channel is a blue channel.

More specifically, in this embodiment, the current gain information and the reference gain information may respectively include red gain values corresponding to the red channel and blue gain values corresponding to the blue channel. Accordingly, when detecting the current light source to perform the white balance process, the white balance module 450 may obtain the red and blue gain values with respect to the current light source and adjust the image by using the corresponding red and blue gain values to avoid a color shift of the image due to the difference in light sources.

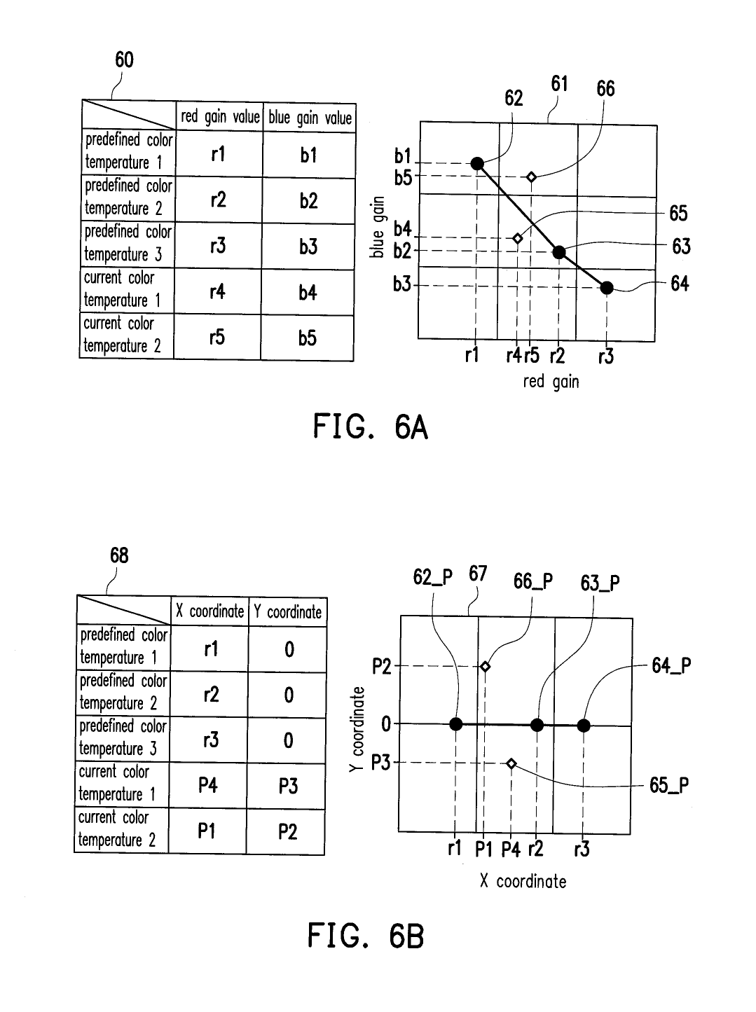

Specifically, FIG. 6A is a schematic view illustrating a relation between color temperature and white balance gain according to an embodiment of the invention. Referring to FIG. 6A, a table 60 shows red and blue gain values of the three predefined color temperatures and red and blue gain values of two current color temperatures. In addition, the red gain value corresponding to “predefined color temperature1” is r1, and the blue gain value thereof is b1. The red gain value corresponding to “predefined color temperature 2” is r2, and the blue gain value thereof is b2. The red gain value corresponding to “predefined color temperature 3” is r3, and the blue gain value thereof is b3. Besides, if a color temperature of the current light source is detected by the white balance module 452 to be “current color temperature 1”, the corresponding red gain value is r4, and the blue gain value is b4. If the color temperature of the current light source is detected by the white balance module 452 to be “current color temperature 2”, the corresponding red gain value is r5, and the blue gain value is b5.

In addition, based on the table 60, a relation diagram 61 between the red and blue gain values is illustrated. In the relation diagram 61, coordinate spots 62, 63, and 64 respectively correspond to “predefined color temperature 1”, “predefined color temperature 2”, and “predefined color temperature 3”, while coordinate spots 65 and 66 respectively correspond to “current color temperature 1” and “current color temperature 2”. However, the relation diagram 61 is only intended for exemplary description, and the invention is not limited thereto. People having ordinary skills in the art may produce a relation diagram between the corresponding red and blue gain values based on the actual situation.

Then, at Step 503, the parameter determining module 453 may use a projection function to determine an index position of the current gain information. More specifically, the projection function may be considered as a relation for coordinate transformation, and the projection function is generated based on the reference gain information corresponding to the plurality of predefined color temperatures. Specifically speaking, when it is intended to obtain a modifying parameter for the red gain value, FIG. 6B is a schematic view illustrating coordinate positions after transformation according to an embodiment of the invention. Referring to FIGS. 6A and 6B simultaneously, the projection function of this embodiment is a transformational function obtained by projecting the coordinate points 62, 63, and 64 onto X-axis. A table 68 shows reference positions and index positions, wherein the reference positions are obtained by transforming the reference gain information and the index positions are obtained by transforming the current gain information.

As shown in the table 68, an X coordinate that “predefined color temperature 1” corresponds to is r1, and a Y coordinate thereof is 0. An X coordinate that “predefined color temperature 2” corresponds to is r2 and a Y coordinate thereof is 0. An X coordinate that “predefined color temperature 3” corresponds to is r3 and a Y coordinate thereof is 0. Moreover, an X coordinate that “current color temperature 1” corresponds to is P4, and a Y coordinate thereof is P3. An X coordinate that “current color temperature 2” corresponds to is P1, and a Y coordinate thereof is P2.

Based on the table 68, a projected coordinate diagram 67 of the relation diagram 61 is drawn. Reference positions 62_P, 63_P, and 64_P respectively correspond to “predefined color temperature 1”, “predefined color temperature 2”, and “predefined color temperature 3”, while index positions 65_P and 66_P respectively correspond to “current color temperature 1” and “current color temperature 2”. In other words, through transformation of the projection function, the reference determining module 453 may be informed that a coordinate of the index position 65_P of “current color temperature 1” is (P4, P3) based on the red gain value r4 and the blue gain value b4 of “current color temperature 1”. Similarly, through transformation of the projection function, the reference determining module 453 may be informed that a coordinate of the index position 66_P of “current color temperature 2” is (P1, P2) based on the red gain value r5 and the blue gain value b5 of “current color temperature 2”. Moreover, people having ordinary skills in the art may, based on the description, infer how to obtain the index position of the current gain value when intending to obtain a modifying parameter of the blue gain value.

Then, at step S504, the interpolating process module 456 may, based on the index position of the current gain information, perform linear interpolation to the plurality of predefined compensation tables to generate the first shading compensation table. Based on the above, it can be known that the predefined compensation tables respectively correspond to the plurality of predefined color temperatures mutually different from each other. For example, in the example shown in FIG. 6B, “predefined color temperature 1”, “predefined color temperature 2”, and “predefined color temperature 3” respectively have corresponding predefined compensation tables. Therefore, based on the index position that the current color temperature corresponds to, the interpolating process module 456 may perform interpolation based on the predefined compensation tables that “predefined color temperature 1”, “predefine color temperature 2”, and “predefine color temperature 3” correspond to, so as to obtain the first shading compensation table. More specifically, if the current light source corresponds to “current color temperature 1”, interpolation maybe performed to the predefined compensation table of “predefined color temperature 1” and the predefined compensation table of “predefined color temperature 2” to obtain the first shading compensation table. Besides, since the index positions that “current color temperature 1” and “current color temperature 2” correspond to are different, the first shading compensation table of “current color temperature 1” generated through interpolation and the first shading compensation table of “current color temperature 2” generated through interpolation are also different.

Back to the flowchart shown in FIG. 5, at Step S505, the reference determining module 453 determines the modifying parameter based on the index position and the plurality of reference positions respectively corresponding to the reference gain information. More specifically, the reference determining module 453 may compute a difference between the current gain information and the reference gain information based on the index position of the current gain information and the reference positions of the reference gain information. Therefore, the parameter determining module 453 may determine the modifying parameter based on the difference. Taking “current color temperature 2” in FIG. 6B as an example, based on distances between the index position 66_P of “current color temperature 2” and the reference position 62_P, the reference position 63_P, and the reference position 64_P, or based on a distance between the index position 66_P of “current color temperature 2” and X-axis, the parameter determining module 453 may determine a modifying parameter of “current color temperature 2”, and the modifying parameter corresponds to the red channel.

Then, at Step S506, the modifying module 454 obtains an adjustment parameter table based on the modifying parameter and a predefined curve. The adjustment parameter table may be adapted to modify each compensation value in the first shading compensation table. Moreover, the modifying parameter may be considered as an overall indicator for adjusting the first shading compensation table. However, a degree of adjustment that each compensation value in the first shading compensation table needs to be adjusted may differ. Therefore, the modifying module 454 of this embodiment may determine the degree of adjustment that each compensation value in the first shading compensation table needs to be adjusted based on the modifying parameter and the predefined curve. In brief, based on setting of the predefined curve, a compensation value at the periphery of the first shading compensation table may correspond to a greater degree of modification, while a compensation value at the center of the first shading compensation table may correspond to a smaller degree of modification. However, people having ordinary skills in the art may determine the predefined curve based on the actual situation.

It should also be noted that the shading compensation table of this embodiment includes the compensation values for compensating the red channel and the compensation values for compensating the blue channel. Therefore, the modifying parameter for modifying the first shading compensation table includes a first adjustment parameter corresponding to the red channel and a second adjustment parameter corresponding to the blue channel. Thus, the modifying module 454 obtains a first adjustment parameter table of the adjustment parameter table based on the first adjustment parameter and a first curve of the predefined curve. In addition, the first adjustment parameter table corresponds to the red channel. In addition, the modifying module 454 obtains a second adjustment parameter table of the adjustment parameter table based on the second adjustment parameter and a second curve of the predefined curve. The second adjustment parameter table corresponds to the blue channel.

Then, at Step S507, the modifying module 454 uses the adjustment parameter table to modify the plurality of compensation values in the first shading compensation table, so as to obtain the second shading compensation table. More specifically, the modifying module 454 uses the first adjustment parameter table to modify a plurality of first channel compensation values corresponding to the red channel in the first shading compensation table. In addition, the second adjustment parameter table is used to modify a plurality of second channel compensation values corresponding to the blue channel in the first shading compensation table. In addition, the modified first channel compensation values and the modified second channel compensation values are recorded as the second shading compensation table. Lastly, at Step S508, the image compensating module 455 compensates the image by using the second shading compensation table so as to generate a compensated image.

It should be noted that in addition to modifying all of the compensation values in the first shading compensation table based on the adjustment parameter table, the image capture device 400 may also modify the first shading compensation table with a simplified data volume. More specifically, in an embodiment, the first shading compensation table may be simplified into a first shading compensation curve by using a 1D vector pruning method, so as to reduce a total load of calculation. Therefore, the modifying module 454 may use an adjustment curve generated based on the predefined curve and the modifying parameter to modify the first shading compensation curve, so as to obtain a second shading compensation curve representing the second shading compensation table so as to significantly reducing the total load of calculation.

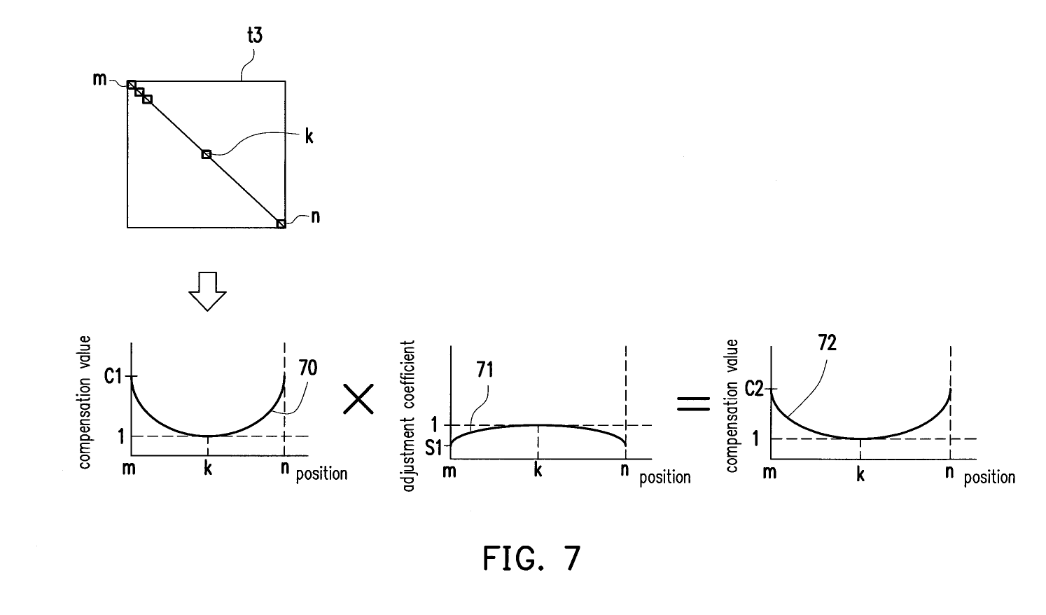

For example, FIG. 7 is a schematic view illustrating obtaining a second shading compensation table according to an embodiment of the invention. Referring to FIG. 7, a first shading compensation table t3 records a plurality of compensation values, and the first shading compensation table t3 may be represented by a first shading compensation curve 70 by using a 1D vector pruning method. More specifically, the first shading compensation curve 70 records compensation values on a diagonal of the first shading compensation table t3. As shown in FIG. 7, the first shading compensation curve 70 records compensation values from a position m to a position n through a position k. Based on the first shading compensation curve 70, it can be known that a compensation value located on a corner position of the first shading compensation table t3 is greater. In addition, a compensation value on the position m of the first shading compensation table t3 is C1, while a compensation value on the position k of the first shading compensation table t3 is 0.

By multiplying each compensation value on the first shading compensation curve 70 with a corresponding adjustment coefficient, a second shading compensation curve 72 may be obtained. In addition, the adjustment coefficients may be represented by an adjustment curve 71, and the adjustment curve 71 is obtained based on the predefined curve and the modifying parameter. More specifically, an adjustment coefficient S1 corresponding to the position M may be obtained based on the modifying parameter, and the adjustment curve 71 may be obtained based on S1 and the predefined curve. In the embodiment shown in FIG. 7, the adjustment curve 71 shows that part of the compensation values in the first shading compensation table are adjusted to be lower due to modification of the adjustment coefficient. For example, a compensation value C2 on the second shading compensation curve is equivalent to the compensation value C1 multiplied with the adjustment coefficient S1, wherein the adjustment coefficient S1 is less than 1, and the compensation value C2 is smaller than the compensation value C1 due to modification of the adjustment coefficient S1. On the contrary, based on a different adjustment parameter, a part of the compensation values in the first shading compensation table may be adjusted to be higher due to the modification of the adjustment coefficient. Therefore, after obtaining the second shading compensation curve 72, the complete second shading compensation table may be obtained by restoring it from the second shading compensation curve 72.

In view of the foregoing, the image capture device is capable of detecting the light source in the shooting environment to obtain the corresponding current white balance gain information. Then, by comparing the current white balance gain value and the plurality of predefined reference gain values, the modifying parameter is obtained. In addition, the modifying parameter is used to modify the shading compensation table directed to a specific color temperature. Therefore, the image capture device according to the embodiments of the invention is capable of generating the shading compensation tables suitable for different light source environments. Accordingly, the embodiments of the invention not only provide a preferable compensation performance to suppress the shading effect, but also avoid color inconsistency in the image after shading compensation, making the image quality of the image capture device further improved. Moreover, the embodiments of the invention further use the 1D vector pruning method to simplify the data volume of the shading compensation table, and using the simplified data volume to modify the shading compensating table, thereby reducing the load of calculation as well as time of calculation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image compensating method for an image capture device, the method comprising:
capturing an image under a current light source;
detecting the current light source and executing a white balance process to obtain current gain information associated with the current light source;
determining a modifying parameter based on the current gain information and a plurality of reference gain information, wherein the reference gain information respectively correspond to a plurality of predefined color temperatures mutually different from each other;
using the modifying parameter to modify a first shading compensation table so as to obtain a second shading compensation table; and
using the second shading compensation table to compensate the image so as to generate a compensated image.

2. The image compensating method as claimed in claim 1, wherein the step of determining the modifying parameter based on the current gain information and the reference gain information comprises:
using a projection function to determine an index position of the current gain information, wherein the projection function is generated based on the reference gain information; and
determining the modifying parameter based on the index position and a plurality of reference positions respectively corresponding to the reference gain information.

3. The image compensating method as claimed in claim 1, wherein before the step of using the modifying parameter to modify the first shading compensation table so as to obtain the second shading compensation table, the method further comprises:
using a projection function to determine an index position of the current gain information, wherein the projection function is generated based on the reference gain information; and
performing a linear interpolation process to a plurality of predefined compensation tables based on the index position so as to generate the first shading compensation table, wherein the predefined compensation tables respectively correspond to the predefined color temperatures mutually different from each other.

4. The image compensating method as claimed in claim 1, wherein the step of using the modifying parameter to modify the first shading compensation table so as to obtain the second shading compensation table comprises:
obtaining an adjustment parameter table based on the modifying parameter and a predefined curve; and
using the adjustment parameter table to modify a plurality of compensation values in the first shading compensation table so as to obtain the second shading compensation table.

5. The image compensating method as claimed in claim 4, wherein the modifying parameter comprises a first adjustment parameter corresponding to a first color channel and a second adjustment parameter corresponding to a second color channel, and the step of obtaining the adjustment parameter table based on the modifying parameter and the predefined curve comprises:
obtaining a first adjustment parameter table of the adjustment parameter table based on the first adjustment parameter and a first curve of the predefined curve, wherein the first adjustment parameter table corresponds to the first color channel; and
obtaining a second adjustment parameter table of the adjustment parameter table based on the second adjustment parameter and a second curve of the predefined curve, wherein the second adjustment parameter table corresponds to the second color channel.

6. The image compensating method as claimed in claim 5, wherein the step of using the adjustment parameter table to modify the plurality of compensation values in the first shading compensation table so as to obtain the second shading compensation table, comprises:
using the first adjustment parameter table to modify a plurality of first channel compensation values corresponding to the first color channel in the first shading compensation table, using the second adjustment parameter table to modify a plurality of second channel compensation values corresponding to the second color channel in the first shading compensation table, and recording the modified first channel compensation values and the modified second channel compensation values as the second shading compensation table.

7. An image capture device, comprising:
a storage unit recording a plurality of modules; and
one or more processing units, coupled to the storage unit, accessing and executing the modules recorded in the storage unit, the modules comprising:
a capturing module, capturing an image under a current light source;
a white balance module, detecting the current light source and executing a white balance process to obtain current gain information associated with the current light source;
a parameter determining module, determining a modifying parameter based on the current gain information and a plurality of reference gain information, wherein the reference gain information respectively correspond to a plurality of predefined color temperatures mutually different from each other;
a modifying module, using the modifying parameter to modify a first shading compensation table so as to obtain a second shading compensation table; and
an image compensating module, using the second shading compensation table to compensate the image so as to generate a compensated image.

8. The image capture device as claimed in claim 7, wherein the parameter determining module uses a projection function to determine an index position of the current gain information, the projection function is generated based on the reference gain information, and the parameter determining module determines the modifying parameter based on the index position and a plurality of reference positions respectively corresponding to the reference gain information.

9. The image capture device as claimed in claim 7, wherein the modelus further comprises:
an interpolation process module, using a projection function to determine an index position of the current gain information, wherein the projection function is generated based on the reference gain information, and
the interpolation process module performs a linear interpolation process to a plurality of predefined compensation tables based on the index position to generate the first shading compensation table, and the predefined compensation tables respectively correspond to the predefined color temperatures mutually different from each other.

10. The image capture device as claimed in claim 7, wherein the modifying module obtains an adjustment parameter table based on the modifying parameter and a predefined curve, and uses the adjustment parameter table to modify a plurality of compensation values in the first shading compensation table so as to obtaining the second shading compensation table.

11. The image capture device as claimed in claim 10, wherein the modifying parameter comprises a first adjustment parameter corresponding to a first color channel and a second adjustment parameter corresponding to a second color channel,
wherein the modifying module obtains a first adjustment parameter table of the adjustment parameter table based on the first adjustment parameter and a first curve of the predefined curve, and the first adjustment parameter table corresponds to the first color channel, and
the modifying module obtains a second adjustment parameter table of the adjustment parameter table based on the second adjustment parameter and a second curve of the predefined curve, and the second adjustment parameter table corresponds to the second color channel.

12. The image capture device as claimed in claim 11, wherein the modifying module uses the first adjustment parameter table to modify a plurality of first channel compensation values corresponding the first color channel in the first shading compensation table, uses the second adjustment parameter table to modify a plurality of second channel compensation values corresponding to the second color channel in the first shading compensation table, and records the modified first channel compensation values and the modified second channel compensation values as the second shading compensation table.
